(19) United States
(12) Patent Application Publication
(10) Pub. No.: US 2020/0377725 A1
(43) Pub. Date: Dec. 3, 2020

(54) RESIN COMPOSITION AND ARTICLE MADE THEREFROM

(71) Applicant: ELITE ELECTRONIC MATERIAL (KUNSHAN) CO., LTD., Kunshan City (CN)

(72) Inventors: Yan ZHANG, Kunshan City (CN); Zhenfang SHANG, Kunshan City (CN); Rongtao WANG, Kunshan City (CN); Mingsheng YUAN, Kunshan City (CN)

(21) Appl. No.: 16/522,562

(22) Filed: Jul. 25, 2019

(30) Foreign Application Priority Data
May 31, 2019 (CN) 201910469516.3

(51) Int. Cl. C08L 79/08; C08K 3/013; C08J 5/24; C08L 71/12; C08L 23/02

(52) U.S. Cl. CPC C08L 79/085; C08K 3/013; C08J 5/24; C08L 2203/20; C08L 23/02; C08L 2203/16; C08L 71/12

(57) ABSTRACT

A resin composition includes a first maleimide resin and a second maleimide resin which is different from the first maleimide resin. The resin composition may be used to make various articles, such as a prepreg, a resin film, a resin-coated copper, a laminate or a printed circuit board, and achieve improvements in at least one, more or all properties including varnish solubility, varnish shelf life, prepreg appearance, radial flow via fill factor, laminate appearance, copper foil peeling strength, and glass transition temperature; in addition, the manufacturing of various articles is free of nitrogen oxide pollutant emission.

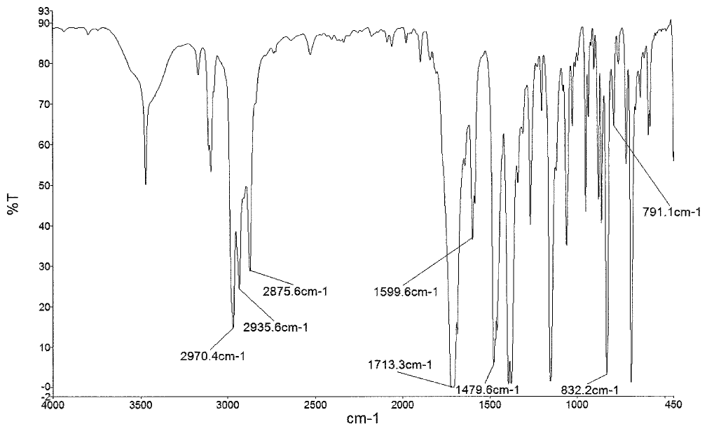

### CROSS-REFERENCE TO RELATED APPLICATION

This application claims the priority benefits of China Patent Application No. 201910469516.3, filed on May 31, 2019, the entirety of which is hereby incorporated by reference herein and made as a part of this specification.

### BACKGROUND

### 1. Field of the Disclosure

The present disclosure relates to a resin composition and more particularly to a resin composition useful for preparing an article such as a prepreg, a resin film, a resin-coated copper, a laminate or a printed circuit board.

### 2. Description of Related Art

With the advent of 5G communication, the signal transmission frequency and transmission speed of mobile communication have been increased gradually, and fine traces of printed circuit boards for mobile communication have been improved to 35 μm or less, which requires uniform and smooth surfaces of insulation materials in printed circuit boards for mobile communication as well as high reliability. On the other hand, to comply with national policy on ecology protection and pollution control, prevention and reduction of emission of pollutants produced during manufacturing of various articles have become the current trend of environmental protection in the electronic industry.

Conventionally, to achieve high reliability, maleimide resins were usually chosen to make laminates and printed circuit boards; however, a resin system containing a maleimide resin has the disadvantages such as poor varnish solubility and undesirable precipitation problem, which fail to provide uniform and smooth prepreg appearance and laminate appearance and therefore fail to meet the demand in use. To address this issue, there were two solutions used in the conventional technology. First, the amount of eco-friendly solvents can be increased, but this will further worsen the defects in prepreg appearance and laminate appearance and will cause the problems of low copper foil peeling strength and low radial flow via fill factor. Second, strong polar solvents can be used to completely dissolve the maleimide resin, such as N,N-dimethylformamide (DMF), N,N-dimethylacetamide (DMAC), N-methylpyrrolidone (NMP) etc., but this will lead to large amount of nitrogen oxide emission during the manufacturing process of various articles and therefore not in compliance with national environmental protection regulations.

### SUMMARY

In view of the problems facing prior arts, particularly one or more technical problems associated with conventional materials failing to meet the demands of varnish solubility, varnish shelf life, prepreg appearance, radial flow via fill factor, laminate appearance, copper foil peeling strength, glass transition temperature and free of nitrogen oxide pollutant emission during the manufacturing process of various articles, the present disclosure provides a resin composition, comprising:
a first maleimide resin comprising a monomer of Formula (1) and/or a polymer thereof:

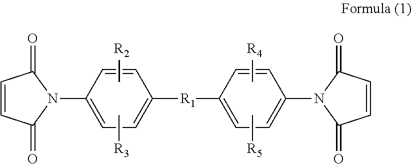

wherein R₁ is a covalent bond, —CH₂—, —CH(CH₃)—, —C(CH₃)₂—, —O—, —S—, —SO₂— or a carbonyl group; R₂, R₃, R₄ and R₅ each independently represent a hydrogen atom or an alkyl group, and at least one of R₂, R₃, R₄ and R₅ is an alkyl group having three or more carbon atoms; and
a second maleimide resin, not comprising the monomer of Formula (1) and/or a polymer thereof, i.e., the second maleimide resin being different from the first maleimide resin.

In the resin composition, the first maleimide resin and the second maleimide resin have a weight ratio of 1.0:9.0 to 7.5:2.5.

Preferably, the first maleimide resin of the present disclosure comprises a structure of Formula (2) to Formula (4) or a combination thereof:

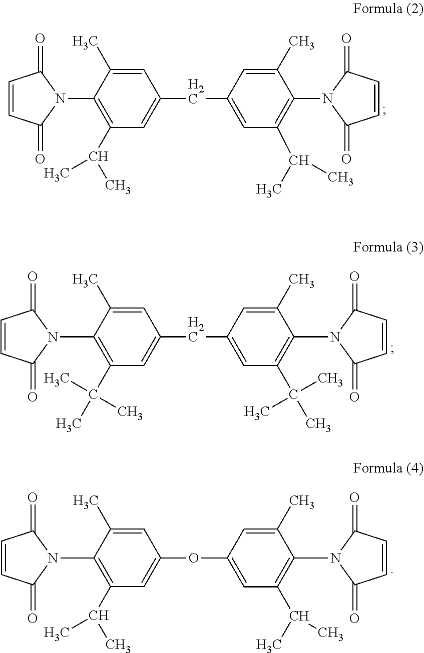 [SMILES: Cc1cc(Cc2cc(C)c(N3C(=O)C=CC3=O)c(C(C)C)c2)cc(C(C)C)c1N1C(=O)C=CC1=O ; Cc1cc(Cc2cc(C)c(N3C(=O)C=CC3=O)c(C(C)(C)C)c2)cc(C(C)(C)C)c1N1C(=O)C=CC1=O ; Cc1cc(Oc2cc(C)c(N3C(=O)C=CC3=O)c(C(C)C)c2)cc(C(C)C)c1N1C(=O)C=CC1=O]

Examples of the second maleimide resin are not particularly limited and, in addition to being different from the first maleimide resin, the second maleimide resin may comprise, but not limited to, various maleimide resins known in the art, including 4,4′-diphenylmethane bismaleimide, oligomer of phenylmethane maleimide (a.k.a., polyphenylmethane maleimide), bisphenol A diphenyl ether bismaleimide, 3,3′-dimethyl-5,5′-diethyl-4,4′-diphenylmethane bismaleimide, m-phenylene bismaleimide, 4-methyl-1,3-phenylene bismaleimide, 1,6-bismaleimide-(2,2,4-trimethyl)hexane, N-2,3-xylylmaleimide, N-2,6-xylylmaleimide, N-phenylmaleimide, vinyl benzyl maleimide (VBM), maleimide resin containing aliphatic long chain structure, prepolymer of diallyl compound and maleimide resin, prepolymer of diamine and maleimide resin, prepolymer of multi-functional amine and maleimide resin, prepolymer of acid phenol compound and maleimide resin, or a combination thereof.

In addition to the first maleimide resin and the second maleimide resin, the resin composition of the present disclosure may further comprise an unsaturated bond-containing resin.

Examples of the unsaturated bond-containing resin are not particularly limited and may comprise, but not limited to, various unsaturated bond-containing resins known in the art, including unsaturated bond-containing polyphenylene oxide (a.k.a., polyphenylene ether) and/or a modification thereof, polyolefin and/or a modification thereof, bis(vinylbenzyl) ether (BVBE) and/or a modification thereof, 1,2-bis(vinylphenyl) ethane (BVPE) and/or a modification thereof, divinylbenzene (DVB) and/or a modification thereof, triallyl isocyanurate (TAIC) and/or a modification thereof, triallyl cyanurate (TAC) and/or a modification thereof, 1,2,4-trivinyl cyclohexane (TVCH) and/or a modification thereof, diallyl bisphenol A (DABPA) and/or a modification thereof, styrene and/or a modification thereof, acrylate and/or a modification thereof, or a combination thereof.

Examples of the modification described above may comprise, but not limited to, a product derived from an unsaturated bond-containing resin with its reactive functional group modified, a product derived from a prepolymerization reaction of an unsaturated bond-containing resin and other resins, a product derived from a crosslinking reaction of an unsaturated bond-containing resin and other resins, a product derived from homopolymerizing an unsaturated bond-containing resin, a product derived from copolymerizing an unsaturated bond-containing resin and another different unsaturated bond-containing resin, etc.

Preferably, the unsaturated bond-containing resin comprises unsaturated bond-containing polyphenylene oxide and/or a modification thereof, polyolefin and/or a modification thereof, or a combination thereof.

Unless otherwise specified, the aforesaid unsaturated bond-containing resin may be present as a monomer, an oligomer (which may be a homopolymer, a copolymer, or a prepolymer, etc.), a polymer (which may be a homopolymer, a copolymer, or a prepolymer, etc.), or a combination thereof. For example, the unsaturated bond-containing resin may comprise one or more monomers, oligomers, polymers, or a combination thereof.

Preferably, the resin composition disclosed herein may comprise 10 parts by weight to 60 parts by weight of a combination of the first maleimide resin and the second maleimide resin and 5 parts by weight to 70 parts by weight of the unsaturated bond-containing resin.

Preferably, the resin composition disclosed herein may comprise 10 parts by weight to 60 parts by weight of a combination of the first maleimide resin and the second maleimide resin and 25 parts by weight to 70 parts by weight of the unsaturated bond-containing resin.

Preferably, the resin composition disclosed herein may comprise 10 parts by weight to 60 parts by weight of a combination of the first maleimide resin and the second maleimide resin and 25 parts by weight to 55 parts by weight of the unsaturated bond-containing resin.

Preferably, the resin composition disclosed herein may comprise 10 parts by weight to 60 parts by weight of a combination of the first maleimide resin and the second maleimide resin and 40 parts by weight to 55 parts by weight of the unsaturated bond-containing resin.

Preferably, the resin composition disclosed herein may comprise 10 parts by weight to 60 parts by weight of a combination of the first maleimide resin and the second maleimide resin, 20 parts by weight to 50 parts by weight of the unsaturated bond-containing polyphenylene oxide and/or a modification thereof, and 5 parts by weight to 20 parts by weight of the polyolefin and/or a modification thereof.

In addition to the first maleimide resin and the second maleimide resin, the resin composition may optionally further comprise epoxy resin and/or a modification thereof, cyanate ester resin and/or a modification thereof, phenolic resin and/or a modification thereof, benzoxazine resin and/or a modification thereof, styrene maleic anhydride resin and/or a modification thereof, polyester and/or a modification thereof, amine curing agent and/or a modification thereof, polyamide and/or a modification thereof, polyimide and/or a modification thereof, or a combination thereof.

In addition to the first maleimide resin and the second maleimide resin, the resin composition may optionally further comprise flame retardant, inorganic filler, curing accelerator, solvent, silane coupling agent, surfactant, coloring agent, toughening agent or a combination thereof.

Preferably, the solvent is absent of nitrogen in its molecular structure. For example, the solvent may comprise, but not limited to, methanol, ethanol, ethylene glycol monomethyl ether, acetone, butanone (a.k.a. methyl ethyl ketone), methyl isobutyl ketone, cyclohexanone, toluene, xylene, methoxyethyl acetate, ethoxyethyl acetate, propoxyethyl acetate, ethyl acetate, propylene glycol methyl ether, or a mixture thereof.

The resin compositions of various embodiments may be useful for making different articles, including but not limited to a prepreg, a resin film, a resin-coated copper, a laminate or a printed circuit board.

In a preferred embodiment, articles made from the resin composition disclosed herein have one, more or all of the following properties:

higher glass transition temperature, such as a glass transition temperature as measured by using a dynamic mechanical analyzer by reference to IPC-TM-650 2.4.24.4 of greater than or equal to 250° C., such as between 250° C. and 275° C. or between 251° C. and 271° C.;

higher copper foil peeling strength, such as a copper foil peeling strength as measured by using a tensile strength tester by reference to IPC-TM-650 2.4.8 of greater than or equal to 3.5 lb/in, such as between 3.5 lb/in and 4.5 lb/in; and

free of nitrogen oxide pollutant emission during the manufacturing process of various articles made from the resin composition of the present disclosure.

### BRIEF DESCRIPTION OF THE DRAWINGS

The sole FIGURE illustrates the FTIR spectrum of Product A1.

### DETAILED DESCRIPTION OF EMBODIMENTS

To enable those skilled in the art to further appreciate the features and effects of the present disclosure, words and terms contained in the specification and appended claims are described and defined. Unless otherwise defined, all technical and scientific terms used herein have the same meaning as commonly understood by those of ordinary skill in the art to which this disclosure pertains. In the case of conflict, the present document and definitions contained herein will control.

While some theories or mechanisms may be proposed herein, the present disclosure is not bound by any theories or mechanisms described regardless of whether they are right or wrong, as long as the embodiments can be implemented according to the present disclosure.

As used herein, “a,” “an” or any similar expression is employed to describe components and features of the present disclosure. This is done merely for convenience and to give a general sense of the scope of the present disclosure. Accordingly, this description should be read to include one or at least one and the singular also includes the plural unless it is obvious to mean otherwise.

As used herein, the term “comprises,” “comprising,” “includes,” “including,” “has,” “having” or any other variant thereof is construed as an open-ended transitional phrase intended to cover a non-exclusive inclusion. For example, a composition or manufacture that comprises a list of elements is not necessarily limited to only those elements but may include other elements not expressly listed or inherent to such composition or manufacture. Further, unless expressly stated to the contrary, the term “or” refers to an inclusive or and not to an exclusive or. For example, a condition “A or B” is satisfied by any one of the following: A is true (or present) and B is false (or not present), A is false (or not present) and B is true (or present), and both A and B are true (or present). In addition, whenever open-ended transitional phrases are used, such as “comprises,” “comprising,” “includes,” “including,” “has,” “having” or any other variant thereof, it is understood that close-ended transitional phrases such as “consisting of,” “composed by” and “remainder being” and partially open-ended transitional phrases such as “consisting essentially of,” “primarily consisting of,” “mainly consisting of,” “primarily containing,” “composed essentially of,” “essentially having,” etc. are also disclosed and included.

In this disclosure, features and conditions such as values, numbers, contents, amounts or concentrations presented as a numerical range or a percentage range are merely for convenience and brevity. Therefore, a numerical range or a percentage range should be interpreted as encompassing and specifically disclosing all possible subranges and individual numerals or values therein, including integers and fractions, particularly all integers therein. For example, a range of “1.0 to 8.0” should be understood as explicitly disclosing all subranges such as 1.0 to 7.0, 2.0 to 8.0, 2.0 to 6.0, 3.0 to 6.0, 4.0 to 8.0, 3.0 to 8.0 and so on, particularly subranges defined by integers, as well as disclosing all individual values such as 1.0, 2.0, 3.0, 4.0, 5.0, 6.0, 7.0 and 8.0. Similarly, a range of “between 1.0 and 8.0” should be understood as explicitly disclosing all ranges such as 1.0 to 8.0, 1.0 to 7.0, 2.0 to 8.0, 2.0 to 6.0, 3.0 to 6.0, 4.0 to 8.0, 3.0 to 8.0 and so on and encompassing the end points of the ranges. Unless otherwise defined, the aforesaid interpretation rule should be applied throughout the present disclosure regardless broadness of the scope.

Whenever amount, concentration or other numeral or parameter is expressed as a range, a preferred range or a series of upper and lower limits, it is understood that all ranges defined by any pair of the upper limit or preferred value and the lower limit or preferred value are specifically disclosed, regardless whether these ranges are explicitly described or not. In addition, unless otherwise defined, whenever a range is mentioned, the range should be interpreted as inclusive of the endpoints and every integers and fractions in the range.

Given the intended purposes and advantages of this disclosure are achieved, numerals or figures have the precision of their significant digits. For example, 40.0 should be understood as covering a range of 39.50 to 40.49.

As used herein, a Markush group or a list of items is used to describe examples or embodiments of the present disclosure. A skilled artisan will appreciate that all subgroups of members or items and individual members or items of the Markush group or list can also be used to describe the present disclosure. For example, when X is described as being “selected from a group consisting of X₁, X₂ and X₃,” it is intended to disclose the situations of X is X₁ and X is X₁ and/or X₂ and/or X₃. In addition, when a Markush group or a list of items is used to describe examples or embodiments of the present disclosure, a skilled artisan will understand that any subgroup or any combination of the members or items in the Markush group or list may also be used to describe the present disclosure. Therefore, when X is described as being “selected from a group consisting of X₁, X₂ and X₃” and Y is described as being “selected from a group consisting of Y₁, Y₂ and Y₃,” the disclosure encompasses any combination of X is X₁ and/or X₂ and/or X₃ and Y is Y₁ and/or Y₂ and/or Y₃.

As used herein, “or a combination thereof” means “or any combination thereof”, and “a” and “an” mean “any”.

Unless otherwise specified, the term “resin” of the present disclosure is construed as comprising monomer, polymer or a combination thereof, but not limited thereto. A polymer refers to a chemical substance formed by one, two or more monomers via polymerization and may comprise a homopolymer, a copolymer, a prepolymer, etc., but not limited thereto. In addition, the term “polymer” includes but is not limited to an oligomer. An oligomer refers to a polymer with 2-20, typically 2-5, repeating units. For example, in the present disclosure, the term “maleimide resin” is construed to encompass a maleimide monomer, a maleimide polymer, a combination of maleimide monomers, a combination of maleimide polymers, and a combination of maleimide monomer(s) and maleimide polymer(s).

Unless otherwise specified, according to the present disclosure, a compound refers to a chemical substance formed by two or more elements bonded with chemical bonds.

Unless otherwise specified, according to the present disclosure, a modification comprises a product derived from a resin with its reactive functional group modified, a product derived from a prepolymerization reaction of a resin and other resins, a product derived from a crosslinking reaction of a resin and other resins, a product derived from homopolymerizing a resin, a product derived from copolymerizing a resin and other resins, etc.

It should be understood that all features disclosed herein may be combined in any way to constitute the solution of the present disclosure, as long as there is no conflict present in the combination of these features.

Examples and embodiments are described in detail below. It will be understood that these examples and embodiments are exemplary only and are not intended to limit the scope and use of the present disclosure. Unless otherwise specified, processes, reagents and conditions described in the examples are those known in the art.

For example, the present disclosure provides a resin composition, comprising:
a first maleimide resin comprising a monomer of Formula (1) and/or a polymer thereof:

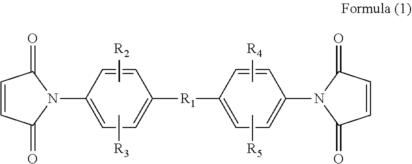

wherein R₁ is a covalent bond, —CH₂—, —CH(CH₃)—, —C(CH₃)₂—, —O—, —S—, —SO₂— or a carbonyl group; R₂, R₃, R₄ and R₅ each independently represent a hydrogen atom or an alkyl group, and at least one of R₂, R₃, R₄ and R₅ is an alkyl group having three or more carbon atoms; and
a second maleimide resin, not comprising the monomer of Formula (1) and/or a polymer thereof, i.e., the second maleimide resin being different from the first maleimide resin.

As used herein, unless otherwise specified, an alkyl group represents a straight-chain or branch-chain saturated hydrocarbyl group, such as a C₁ to C₆ saturated hydrocarbyl group, including but not limited to methyl, ethyl, propyl, isopropyl, butyl, tert-butyl, pentyl, hexyl, etc.

In some embodiments, R₂, R₃, R₄ or R₅ at least comprises a propyl or a tert-butyl.

In some embodiments, the first maleimide resin of the present disclosure preferably comprises a structure of Formula (2) to Formula (4) or a combination thereof:

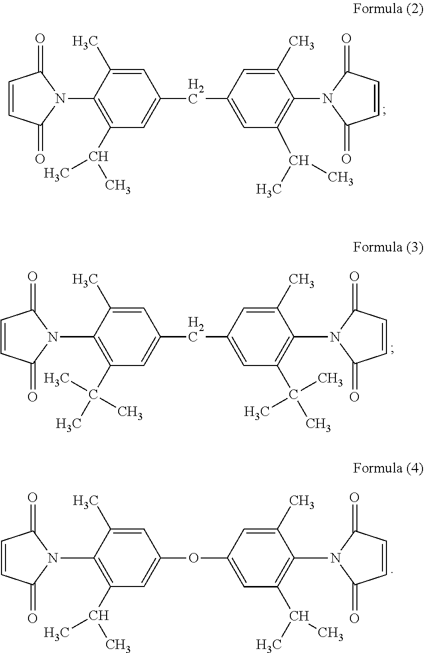 [SMILES: Cc1cc(Cc2cc(C)c(N3C(=O)C=CC3=O)c(C(C)C)c2)cc(C(C)C)c1N1C(=O)C=CC1=O ; Cc1cc(Cc2cc(C)c(N3C(=O)C=CC3=O)c(C(C)(C)C)c2)cc(C(C)(C)C)c1N1C(=O)C=CC1=O ; Cc1cc(Oc2cc(C)c(N3C(=O)C=CC3=O)c(C(C)C)c2)cc(C(C)C)c1N1C(=O)C=CC1=O]

The second maleimide resin of the present disclosure comprises a monomer containing at least one maleimide group, its oligomer, its polymer, its prepolymer or a combination thereof. Unless otherwise specified, the second maleimide resin used in the present disclosure, which is different from the first maleimide resin, is not particularly limited and may include any one or more maleimide resins or a combination thereof suitable for preparing a prepreg, a resin film, a resin-coated copper, a laminate or a printed circuit board. In some embodiments, the second maleimide resin may comprise any one or a combination of 4,4′-diphenylmethane bismaleimide, oligomer of phenylmethane maleimide (a.k.a., polyphenylmethane maleimide), bisphenol A diphenyl ether bismaleimide, 3,3′-dimethyl-5,5′-diethyl-4,4′-diphenyl methane bismaleimide, m-phenylene bismaleimide, 4-methyl-1,3-phenylene bismaleimide, 1,6-bismaleimide-(2,2,4-trimethyl)hexane, N-2,3-xylylmaleimide, N-2,6-xylenemaleimide, N-phenylmaleimide, vinyl benzyl maleimide (VBM), maleimide resin containing aliphatic long chain structure, prepolymer of diallyl compound and maleimide resin, prepolymer of diamine and maleimide resin, prepolymer of multi-functional amine and maleimide resin, and prepolymer of acid phenol compound and maleimide resin.

For example, the second maleimide resin may include products such as BMI-1000, BMI-1000H, BMI-1100, BMI-1100H, BMI-2000, BMI-2300, BMI-3000, BMI-3000H, BMI-4000, BMI-5000, BMI-5100, BMI-TMH, BMI-7000 and BMI-7000H available from Daiwakasei Industry Co., Ltd., or products such as BMI-70 and BMI-80 available from K.I Chemical Industry Co., Ltd.

For example, the maleimide resin containing aliphatic long-chain structure may include products such as BMI-689, BMI-1400, BMI-1500, BMI-1700, BMI-2500, BMI-3000, BMI-5000 and BMI-6000 available from Designer Molecules Inc.

According to the present disclosure, the first maleimide resin and the second maleimide resin are present at a weight ratio of 1.0:9.0 to 7.5:2.5. In some embodiments, the first maleimide resin and the second maleimide resin may have a weight ratio of such as 1.0:9.0, 1.5:8.5, 2.0:8.0, 2.5:7.5, 3.0:7.0, 3.5:6.5, 4.0:6.0, 4.5:5.5, 5.0:5.0, 5.5:4.5, 6.0:4.0, 6.5:3.5, 7.0:3.0 or 7.5:2.5, but not limited thereto. For example, the first maleimide resin and the second maleimide resin may have a weight ratio of 4.2:5.8.

In addition to the first maleimide resin and the second maleimide resin, the resin composition of the present disclosure may further comprise an unsaturated bond-containing resin.

The unsaturated bond-containing resin described herein comprises one or more unsaturated bonds per molecule. Unless otherwise specified, the unsaturated bond of the unsaturated bond-containing resin refers to a reactive unsaturated bond, such as but not limited to an unsaturated double bond with the potential of being crosslinked with other functional groups, such as an unsaturated carbon-carbon double bond with the potential of being crosslinked with other functional groups, but not limited thereto.

Examples of the unsaturated bond-containing resin are not particularly limited and may comprise, but not limited to, various unsaturated bond-containing resins known in the art, including but not limited to unsaturated bond-containing polyphenylene oxide and/or a modification thereof, polyolefin and/or a modification thereof, bis(vinylbenzyl) ether (BVBE) and/or a modification thereof, 1,2-bis(vinylphenyl) ethane (BVPE) and/or a modification thereof, divinylbenzene (DVB) and/or a modification thereof, triallyl isocyanurate (TAIC) and/or a modification thereof, triallyl cyanurate (TAC) and/or a modification thereof, 1,2,4-trivinyl cyclohexane (TVCH) and/or a modification thereof, diallyl bisphenol A (DABPA) and/or a modification thereof, styrene and/or a modification thereof, acrylate and/or a modification thereof, or a combination thereof.

For example, the unsaturated bond-containing resin preferably comprises unsaturated bond-containing polyphenylene oxide and/or a modification thereof, polyolefin and/or a modification thereof, or a combination thereof.

Unless otherwise specified, relative to a total of 1 part by weight to 100 parts by weight of the combination of the first maleimide resin and the second maleimide resin, the unsaturated bond-containing resin described above may range from 1 part by weight to 100 parts by weight, and the ratio therebetween can be adjusted according to the need.

For example, relative to a total of 10 parts by weight to 60 parts by weight of the combination of the first maleimide resin and the second maleimide resin, the unsaturated bond-containing resin is 5 parts by weight to 70 parts by weight.

For example, relative to a total of 10 parts by weight to 60 parts by weight of the combination of the first maleimide resin and the second maleimide resin, the unsaturated bond-containing resin is 25 parts by weight to 70 parts by weight.

For example, relative to a total of 10 parts by weight to 60 parts by weight of the combination of the first maleimide resin and the second maleimide resin, the unsaturated bond-containing resin is 25 parts by weight to 55 parts by weight.

For example, relative to a total of 10 parts by weight to 60 parts by weight of the combination of the first maleimide resin and the second maleimide resin, the unsaturated bond-containing resin is 40 parts by weight to 55 parts by weight.

Unsaturated bond-containing polyphenylene oxide and/or a modification thereof suitable for the present disclosure is not particularly limited and may comprise any one or more commercially available products, self-prepared products or a combination thereof. Generally, unsaturated bond-containing polyphenylene oxide suitable for the present disclosure may have a structure of Formula (5):

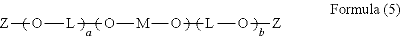

wherein a and b are individually a positive integer of 1 to 30, preferably a positive integer of 1 to 10, and more preferably a positive integer of 1 to 5;
—(O-M-O)— has a structure of Formula (6) or Formula (7):

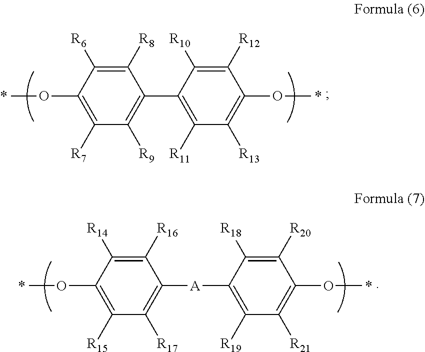

L has a structure of Formula (8):

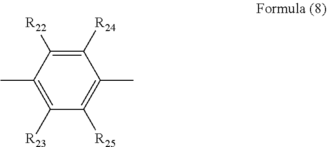

wherein R₆, R₇, R₁₂ and R₁₃ are the same or different and are individually a halogen atom, a C₁-C₆ alkyl group or a phenyl group; R₈, R₉, R₁₀ and R₁₁ are the same or different and are individually a hydrogen atom, a halogen atom, a C₁-C₆ alkyl group or a phenyl group; in some embodiments, R₆, R₇, R₈, R₁₁, R₁₂ and R₁₃ are individually a methyl group; R₁₄, R₁₅, R₁₆, R₁₇, R₁₈, R₁₉, R₂₀ and R₂₁ are the same or different and are individually a halogen atom, a C₁-C₆ alkyl group, a phenyl group or a hydrogen atom; in some embodiments, R₁₄, R₁₅, R₂₀ and R₂₁ are individually a methyl group;
A is a C₁-C₂₀ straight-chain hydrocarbyl group, a C₁-C₂₀ branch-chain hydrocarbyl group (such as alkyl group) or a C₃-C₂₀ cyclohydrocarbyl group (such as cycloalkyl group), preferably —CH₂— or —C(CH₃)₂—;
R₂₂, R₂₃, R₂₄ and R₂₅ are the same or different and are individually a hydrogen atom, a halogen atom, a C₁-C₆ alkyl group or a phenyl group;
Z has a structure of Formula (9), Formula (10) or Formula (11):

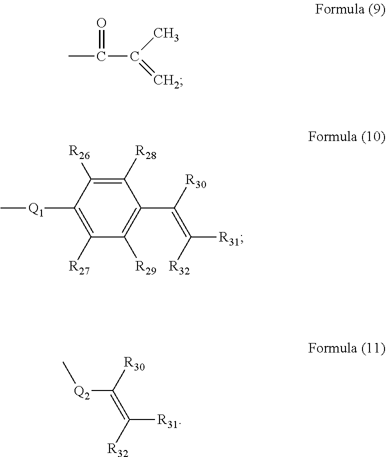

Wherein R₃₁ and R₃₂ are both a hydrogen atom, R₂₆, R₂₇, R₂₈, R₂₉ and R₃₀ are the same or different and are individually a hydrogen atom, a halogen atom, an alkyl group or a haloalkyl group, wherein the alkyl group or haloalkyl group preferably is a C₁-C₆ alkyl group or a halogen-substituted C₁-C₆ alkyl group; Q₁ and Q₂ are individually an organic group with at least one carbon atom, wherein the organic group optionally comprises one or more of a hydrogen atom, an oxygen atom, a nitrogen atom, a sulfur atom and a halogen atom. In some embodiments, Q₁ and Q₂ are individually a methylene group (—CH₂—). In some embodiments, R₂₆ to R₃₀ are individually a hydrogen atom or a C¹-C₆ alkyl group.

In some embodiments, examples of the unsaturated bond-containing polyphenylene oxide include: vinylbenzyl-terminated polyphenylene oxide (e.g., OPE-2st available from Mitsubishi Gas Chemical Co., Inc.), methacrylate-terminated polyphenylene oxide (e.g., SA-9000 available from SABIC), vinylbenzyl-terminated bisphenol A polyphenylene oxide, vinyl-containing chain-extended polyphenylene oxide or a combination thereof. The vinyl-containing chain-extended polyphenylene oxide may include various polyphenylene oxides disclosed in the US Patent Application Publication No. 2016/0185904 A1, all of which are incorporated herein by reference in their entirety.

In some embodiments, relative to a total of 1 part by weight to 100 parts by weight of the combination of the first maleimide resin and the second maleimide resin, the unsaturated bond-containing polyphenylene oxide and/or a modification thereof is 1 part by weight to 100 parts by weight. Preferably, relative to a total of 10 parts by weight to 60 parts by weight of the combination of the first maleimide resin and the second maleimide resin, the unsaturated bond-containing polyphenylene oxide and/or a modification thereof is 20 parts by weight to 50 parts by weight.

Polyolefin and/or a modification thereof suitable for the present disclosure is not particularly limited and may comprise any one or more commercially available products, self-prepared products or a combination thereof. Examples include but are not limited to styrene-butadiene-divinylbenzene terpolymer, hydrogenated styrene-butadiene-divinylbenzene terpolymer, styrene-butadiene-maleic anhydride terpolymer, hydrogenated styrene-butadiene-maleic anhydride terpolymer, vinyl-polybutadiene-urethane oligomer, styrene-butadiene copolymer, hydrogenated styrene-butadiene copolymer, styrene-isoprene copolymer, hydrogenated styrene-isoprene copolymer, maleic anhydride-butadiene copolymer, polybutadiene (homopolymer of butadiene), or a combination thereof.

In some embodiments, the present disclosure uses the styrene-butadiene-divinylbenzene terpolymer (Ricon 257) available from Cray Valley and polybutadiene (B-1000) available from Nippon Soda.

In some embodiments, relative to a total of 1 part by weight to 100 parts by weight of the combination of the first maleimide resin and the second maleimide resin, the polyolefin and/or a modification thereof is 1 part by weight to 100 parts by weight. Preferably, relative to a total of 10 parts by weight to 60 parts by weight of the combination of the first maleimide resin and the second maleimide resin, the polyolefin and/or a modification thereof is 5 parts by weight to 20 parts by weight.

Acrylate and/or a modification thereof suitable for the present disclosure is not particularly limited and may comprise, but not limited to, various acrylates with single functional group, double functional groups, triple functional groups, or multiple functional groups known in the art, such as methacrylate, tricyclodecane di(meth)acrylate (e.g., SR833S, available from Sartomer), tri(meth)acrylate, 1,1′-[(octahydro-4,7-methano-1H-indene-5,6-diyl)bis(methylene)]ester or a combination thereof.

In addition to the components described above, the resin composition disclosed herein may optionally further comprise epoxy resin and/or a modification thereof, cyanate ester resin and/or a modification thereof, phenolic resin and/or a modification thereof, benzoxazine resin and/or a modification thereof, styrene maleic anhydride resin and/or a modification thereof, polyester and/or a modification thereof, amine curing agent and/or a modification thereof, polyamide and/or a modification thereof, polyimide and/or a modification thereof, or a combination thereof.

The epoxy resin and/or a modification thereof suitable for the present disclosure may be any epoxy resins known in the field to which this disclosure pertains, including but not limited to bisphenol A epoxy resin, bisphenol F epoxy resin, bisphenol S epoxy resin, bisphenol AD epoxy resin, novolac epoxy resin, trifunctional epoxy resin, tetrafunctional epoxy resin, multifunctional epoxy resin, dicyclopentadiene (DCPD) epoxy resin, phosphorus-containing epoxy resin, p-xylene epoxy resin, naphthalene epoxy resin (e.g., naphthol epoxy resin), benzofuran epoxy resin, isocyanate-modified epoxy resin, or a combination thereof. The novolac epoxy resin may be phenol novolac epoxy resin, bisphenol A novolac epoxy resin, bisphenol F novolac epoxy resin, biphenyl novolac epoxy resin, phenol benzaldehyde epoxy resin, phenol aralkyl novolac epoxy resin or o-cresol novolac epoxy resin. The phosphorus-containing epoxy resin may be DOPO (9,10-dihydro-9-oxa-10-phosphaphenanthrene-10-oxide) epoxy resin, DOPO-HQ epoxy resin or a combination thereof. The DOPO epoxy resin may be any one, two or more selected from DOPO-containing phenolic novolac epoxy resin, DOPO-containing cresol novolac epoxy resin and DOPO-containing bisphenol-A novolac epoxy resin; the DOPO-HQ epoxy resin may be any one, two or more selected from DOPO-HQ-containing phenolic novolac epoxy resin, DOPO-HQ-containing cresol novolac epoxy resin and DOPO-HQ-containing bisphenol-A novolac epoxy resin.

The cyanate ester resin and/or a modification thereof suitable for the present disclosure is not particularly limited and may be any compound with an Ar—O—C≡N structure, wherein Ar represents a substituted or unsubstituted aromatic group. Examples include but are not limited to novolac cyanate ester resin, bisphenol A cyanate ester resin, bisphenol F cyanate ester resin, dicyclopentadiene-containing cyanate ester resin, naphthalene-containing cyanate ester resin, phenolphthalein cyanate ester resin, adamantane cyanate ester resin or fluorene cyanate ester resin. The novolac cyanate ester resin may be bisphenol A novolac cyanate ester resin, bisphenol F novolac cyanate ester resin, phenol novolac cyanate ester resin or a combination thereof. For example, the cyanate ester resin may be available under the tradename primaset PT-15, PT-30S, PT-60S, BA-200, BA-230S, BA-3000S, BTP-2500, BTP-6020S, DT-4000, DT-7000, ULL-950S, HTL-300, CE-320, LVT-50 or LeCy sold by Lonza.

The phenolic resin and/or a modification thereof suitable for the present disclosure may comprise, but not limited to, mono-functional, bifunctional or multifunctional phenolic resin, comprising phenolic resin of a resin composition conventionally useful for making prepregs, such as phenoxy resin, phenol novolac resin, etc.

The benzoxazine resin and/or a modification thereof suitable for the present disclosure include, but not limited to, bisphenol A benzoxazine resin, bisphenol F benzoxazine resin, phenolphthalein benzoxazine resin, dicyclopentadiene benzoxazine resin, phosphorus-containing benzoxazine resin, oxydianiline benzoxazine resin, or unsaturated bond-containing benzoxazine resin, such as but not limited to LZ-8270, LZ-8280 or LZ-8290 available from Huntsman or HFB-2006M available from Showa High Polymer.

For example, in the styrene maleic anhydride resin and/or a modification thereof, the ratio of styrene (S) to maleic anhydride (MA) may be for example 1/1, 2/1, 3/1, 4/1, 6/1, 8/1 or 12/1, examples including styrene maleic anhydride resins such as SMA-1000, SMA-2000, SMA-3000, EF-30, EF-40, EF-60 and EF-80 available from Cray Valley, or styrene maleic anhydride copolymers such as C400, C500, C700 and C900 available from Polyscope, but not limited thereto.

The polyester and/or a modification thereof suitable for the present disclosure may be any polyester resins known in the field to which this disclosure pertains, including but not limited to various commercially available polyester resin products. Examples include, but not limited to, HPC-8000 and HPC-8150 available from D.I.C. Corporation.

The amine curing agent and/or a modification thereof suitable for the present disclosure may include, but not limited to, any one or a combination of diamino diphenyl sulfone, diamino diphenyl methane, diamino diphenyl ether, diamino diphenyl sulfide and dicyandiamide.

The polyamide and/or a modification thereof suitable for the present disclosure may be any polyamide resins known in the field to which this disclosure pertains, including but not limited to various commercially available polyamide resin products.

The polyimide and/or a modification thereof suitable for the present disclosure may be any polyimide resins known in the field to which this disclosure pertains, including but not limited to various commercially available polyimide resin products.

Moreover, in addition to the aforesaid components, the resin composition disclosed herein may optionally further comprise flame retardant, inorganic filler, curing accelerator, solvent, silane coupling agent, surfactant, coloring agent, toughening agent or a combination thereof.

The flame retardant used herein may be any one or more flame retardants useful for preparing a prepreg, a resin film, a resin-coated copper, a laminate or a printed circuit board; examples of flame retardant include but are not limited to phosphorus-containing flame retardant, preferably comprising any one or a combination selected from the following group: ammonium polyphosphate, hydroquinone bis-(diphenyl phosphate), bisphenol A bis-(diphenylphosphate), tri(2-carboxyethyl) phosphine (TCEP), phosphoric acid tris(chloroisopropyl) ester, trimethyl phosphate (TMP), dimethyl methyl phosphonate (DMMP), resorcinol bis(dixylenyl phosphate) (RDXP, such as commercially available PX-200, PX-201, and PX-202), phosphazene (such as commercially available SPB-100, SPH-100, and SPV-100), melamine polyphosphate, DOPO and its derivatives (such as di-DOPO compounds) or resins, DPPO (diphenylphosphine oxide) and its derivatives (such as di-DPPO compounds) or resins, melamine cyanurate, tri-hydroxy ethyl isocyanurate and aluminium phosphinate (e.g., commercially available OP-930 and OP-935).

For example, the flame retardant may be a DPPO compound (e.g., di-DPPO compound), a DOPO compound (e.g., di-DOPO compound), a DOPO resin (e.g., DOPO-HQ, DOPO-NQ, DOPO-PN, and DOPO-BPN), and a DOPO-containing epoxy resin, wherein DOPO-PN is a DOPO-containing phenol novolac resin, and DOPO-BPN may be a bisphenol novolac resin, such as DOPO-BPAN (DOPO-bisphenol A novolac), DOPO-BPFN (DOPO-bisphenol F novolac) and DOPO-BPSN (DOPO-bisphenol S novolac).

Unless otherwise specified, relative to a total of 1 part by weight to 100 parts by weight of the combination of the first maleimide resin and the second maleimide resin, the flame retardant used in the present disclosure is not particularly limited, and may be used at an amount of 1 part by weight to 100 parts by weight.

The inorganic filler suitable for the present disclosure may be any one or more inorganic fillers useful for preparing a prepreg, a resin film, a resin-coated copper, a laminate or a printed circuit board; examples of inorganic filler include but are not limited to silica (fused, non-fused, porous or hollow type), aluminum oxide, aluminum hydroxide, magnesium oxide, magnesium hydroxide, calcium carbonate, aluminum nitride, boron nitride, aluminum silicon carbide, silicon carbide, titanium dioxide, zinc oxide, zirconium oxide, mica, boehmite (AlOOH), calcined talc, talc, silicon nitride and calcined kaolin. Moreover, the inorganic filler can be spherical, fibrous, plate-like, particulate, sheet-like or whisker-like and can be optionally pretreated by a silane coupling agent. In some embodiments, the present disclosure uses the spherical silica (e.g., SC-2500 SVJ) available from Admatechs.

Unless otherwise specified, relative to a total of 1 part by weight to 100 parts by weight of the combination of the first maleimide resin and the second maleimide resin, the amount of inorganic filler used in the present disclosure is not particularly limited, and may be used at an amount of 10 parts by weight to 300 parts by weight.

The curing accelerator suitable for the present disclosure may comprise a catalyst, such as a Lewis base or a Lewis acid. The Lewis base may comprise any one or a combination of imidazole, boron trifluoride-amine complex, ethyltriphenyl phosphonium chloride, 2-methylimidazole (2MI), 2-phenyl-1H-imidazole (2PZ), 2-ethyl-4-methylimidazole (2E4MI), triphenylphosphine (TPP) and 4-dimethylaminopyridine (DMAP). The Lewis acid may comprise metal salt compounds, such as those of manganese, iron, cobalt, nickel, copper and zinc, such as zinc octanoate or cobalt octanoate. The curing accelerator encompasses curing initiator such as a peroxide capable of producing free radicals, and examples of the curing initiator may comprise, but not limited to: dibenzoyl peroxide (BPO), dicumyl peroxide, 2,5-dimethyl-2,5-di(t-butylperoxy)hexane, 2,5-dimethyl-2,5-di(t-butylperoxy)-3-hexyne (25B), di-t-butyl peroxide, di(t-butylperoxyisopropyl)benzene, di(t-butylperoxy)phthalate, di(t-butylperoxy)isophthalate, t-butyl peroxybenzoate, 2,2-di(t-butylperoxy)butane, 2,2-di(t-butylperoxy)octane, 2,5-dimethyl-2,5-di(benzoylperoxy)hexane, lauroyl peroxide, t-hexyl peroxypivalate, dibutylperoxyisopropylbenzene, bis(4-t-butylcyclohexyl) peroxydicarbonate or a combination thereof.

The purpose of adding solvent according to the present disclosure is to dissolve the components in the resin composition, to change the solid content of the resin composition and to adjust the viscosity of the resin composition. For example, the solvent may comprise, but not limited to, methanol, ethanol, ethylene glycol monomethyl ether, acetone, butanone (methyl ethyl ketone), methyl isobutyl ketone, cyclohexanone, toluene, xylene, methoxyethyl acetate, ethoxyethyl acetate, propoxyethyl acetate, ethyl acetate, propylene glycol methyl ether, or a mixture thereof. The present disclosure does not use nitrogen-containing strong polar solvents such as N,N-dimethylformamide, N,N-dimethylacetamide, N-methylpyrrolidone, etc.

Silane coupling agent suitable for the present disclosure may comprise silane (such as but not limited to siloxane), which may be further categorized according to the functional groups into amino silane, epoxide silane, vinyl silane, ester silane, hydroxyl silane, isocyanate silane, methacryloxy silane and acryloxy silane.

The purpose of surfactant used herein is to ensure uniform distribution of the inorganic filler in the resin composition.

The coloring agent (i.e., staining agent) suitable for the present disclosure may comprise, but not limited to, dye or pigment.

The purpose of toughening agent used herein is to improve the toughness of the resin composition. The toughening agent may comprise, but not limited to, rubber resin, carboxyl-terminated butadiene acrylonitrile rubber (CTBN rubber), core-shell rubber, or a combination thereof.

The resin compositions of various embodiments of the present disclosure may be processed by various methods into different articles, including but not limited to a prepreg, a resin film, a resin-coated copper, a laminate or a printed circuit board.

For example, the resin compositions of various embodiments may be used to make prepregs.

In one embodiment, the prepreg disclosed herein has a reinforcement material and a layered structure formed thereon, wherein the layered structure is made by heating the resin composition to a semi-cured state (B-stage). Suitable baking temperature for making a prepreg may be for example 120° C. to 180° C. The reinforcement material may be any one of a fiber material, woven fabric, and non-woven fabric, and the woven fabric preferably comprises fiberglass fabrics. Types of fiberglass fabrics are not particularly limited and may be any commercial fiberglass fabric useful for various printed circuit boards, such as E-glass fiber fabric, D-glass fiber fabric, S-glass fiber fabric, T-glass fiber fabric, L-glass fiber fabric or Q-glass fiber fabric, wherein the fiber may comprise yarns and rovings, in spread form or standard form. Non-woven fabric preferably comprises liquid crystal polymer non-woven fabric, such as polyester non-woven fabric, polyurethane non-woven fabric and so on, but not limited thereto. Woven fabric may also comprise liquid crystal polymer woven fabric, such as polyester woven fabric, polyurethane woven fabric and so on, but not limited thereto. The reinforcement material may increase the mechanical strength of the prepreg. In one preferred embodiment, the reinforcement material can be optionally pre-treated by a silane coupling agent. The prepreg may be further heated and cured to the C-stage to form an insulation layer.

In one embodiment, by well mixing the resin composition to form a varnish, loading the varnish into an impregnation tank, impregnating a fiberglass fabric into the impregnation tank to adhere the resin composition onto the fiberglass fabric, and proceeding with heating and baking at a proper temperature to a semi-cured state, a prepreg may be obtained.

For example, the article made from the resin composition disclosed herein may be a resin film which is prepared by heating and baking the resin composition to the semi-cured state. For example, by selectively coating the resin composition on a liquid crystal polymer film, a polyethylene terephthalate film (PET film) or a polyimide film, followed by heating and baking to a semi-cured state, a resin film may be obtained.

For example, the article made from the resin composition disclosed herein may be a resin-coated copper (RCC), wherein the resin composition from one embodiment is coated on a copper foil to uniformly adhere the resin composition thereon, followed by heating and baking to a semi-cured state to obtain the resin-coated copper.

For example, the resin composition of the present disclosure may be made into a laminate, which comprises at least two metal foils and an insulation layer disposed between the metal foils, wherein the insulation layer is made by curing the resin composition at high temperature and high pressure to the C-stage, a suitable curing temperature being for example between 190° C. and 220° C. and preferably between 200° C. and 210° C. and a suitable curing time being 90 to 180 minutes and preferably 120 to 150 minutes. The insulation layer may be obtained by curing the aforesaid prepreg or resin film. The metal foil may contain copper, aluminum, nickel, platinum, silver, gold or alloy thereof, such as a copper foil. In a preferred embodiment, the laminate is a copper-clad laminate.

In one embodiment, the laminate may be further processed by trace formation processes to obtain a printed circuit board.

For example, a double-sided copper-clad laminate (such as product EM-827, available from Elite Material Co., Ltd.) with a thickness of 28 mil and having a 1 ounce (oz) HTE (high temperature elongation) copper foil may be used and subject to drilling and then electroplating, so as to form electrical conduction between the upper layer copper foil and the bottom layer copper foil. Then the upper layer copper foil and the bottom layer copper foil are etched to form inner layer circuits. Then brown oxidation and roughening were performed on the inner layer circuits to form uneven structure on the surface to increase roughness. Next, a vacuum lamination apparatus is used to laminate the assembly of a copper foil, the prepreg, the inner layer circuits, the prepreg and a copper foil stacked in said order by heating at 190° C. to 220° C. for 90 to 180 minutes to cure the insulation material of the prepregs. Next, black oxidation, drilling, copper plating and other known circuit board processes are performed on the outmost copper foil so as to obtain the printed circuit board.

In one or more embodiments, the resin composition of the present disclosure and various articles made therefrom may preferably have any one, more or all of the following properties.

In one embodiment, a glass transition temperature as measured by using a dynamic mechanical analyzer by reference to IPC-TM-650 2.4.24.4 is greater than or equal to 250° C., such as between 250° C. and 275° C. or between 251° C. and 271° C.

In one embodiment, a copper foil peeling strength as measured by using a tensile strength tester by reference to IPC-TM-650 2.4.8 is greater than or equal to 3.5 lb/in, such as between 3.5 lb/in and 4.5 lb/in.

In one embodiment, the prepreg has a radial flow via fill factor as measured from a resin filling test of between 0.80 and 1.00 (i.e., between 80% and 100%).

In one embodiment, the manufacturing process of various articles made from the resin composition of the present disclosure is free of nitrogen oxide pollutant emission.

In one embodiment, a varnish prepared from the resin composition of the present disclosure may be completely dissolved at 5° C. to 35° C., and precipitation, turbidity or layer separation will not occur after being stood still for greater than 15 days.

In one embodiment, a prepreg made from the resin composition of the present disclosure is free from crystal grains and sagging on its appearance.

In one embodiment, a laminate made from the resin composition of the present disclosure is free from branch-like pattern, dry board and non-uniform resin flow on its appearance.

Raw materials below were used to prepare the resin compositions of various Examples and Comparative Examples of the present disclosure according to the amount listed in Table 1 and Table 3 and further fabricated to prepare test samples or articles.

The names of chemicals used in the Examples and Comparative Examples are as follows:
1. 3,3′-dimethyl-5,5′-diethyl-4,4′-diphenylmethane bismaleimide, BMI-70, available from K.I Chemical Industry Co., Ltd.
2. 3,3′-dimethyl-5,5′-diethyl-4,4′-diphenylmethane bismaleimide, BMI-5100, available from Daiwakasei Industry Co., Ltd.
3. 4,4′-diphenylmethane bismaleimide, BMI-1000, available from Daiwakasei Industry Co., Ltd.
4. polyphenylmethane maleimide, BMI-2300, available from Daiwakasei Industry Co., Ltd.
5. bisphenol A diphenyl ether bismaleimide, BMI-4000, available from Daiwakasei Industry Co., Ltd.
6. maleimide resin containing aliphatic long chain structure, BMI-3000, available from Designer Molecules Inc.
7. vinylbenzyl-terminated polyphenylene oxide, OPE-2st 1200, available from Mitsubishi Gas Chemical Co., Inc.
8. methacrylate-terminated polyphenylene oxide, SA-9000, available from SABIC.
9. styrene-butadiene-divinylbenzene terpolymer, Ricon 257, available from Cray Valley.
10. polybutadiene, B-1000, available from Nippon Soda Co., Ltd.
11. spherical silica, SC-2500 SVJ, available from Admatechs.
12. 2,5-dimethyl-2,5-di(tert-butylperoxy)-3-hexyne, 25B, available from NOF Corporation.
13. methyl ethyl ketone (MEK) and N,N-dimethylacetamide (DMAC), available from Sinopec Group.

Components A1 to A3 used in Examples E1 to E11 respectively correspond to the products obtained from Preparation Example 1 to Preparation Example 3.

### PREPARATION EXAMPLE 1

98 g of maleic anhydride and a proper amount of toluene were loaded to a reaction tank and fully dissolved by stirring; then 310 g of 3,3′-dimethyl-4,4′-diamino-5,5′-diisopropyl diphenylmethane was fully dissolved in N,N-dimethylformamide (DMF) solvent and loaded to the reaction tank from a constant pressure funnel within 0.5-1 hour; during the addition process, the temperature was kept at 95° C. and the reaction was stirred continuously. After stirring the reaction at 95° C. for another 0.5-1 hour, 10 mL of triethylamine, 200 mL of acetic anhydride and 0.5 g of sodium p-toluenesulfonate were added, followed by stirring the reaction at 95° C. for 3-4 hours and cooling the reaction to room temperature; the obtained solution was treated with iced water to precipitate the product, which was then recrystallized with ethyl acetate and dried to obtain a pale yellow solid Product A1.

Fourier transform infrared spectroscopy (FTIR) analysis of Product A1 prepared in Preparation Example 1, as shown in the sole FIGURE, reveals the presence of C═O, C═C and O═C—N characteristic peaks of maleimide ring at 1713.3 cm⁻¹, 1599.6 cm⁻¹ and 1479.6 cm⁻¹, methyl characteristic peaks at 2970.4 cm⁻¹ and 2875.6 cm⁻¹, isopropyl characteristic peak at 2935.6 cm⁻¹, and characteristic absorption peaks at 832.2 cm⁻¹ and 791.1 cm⁻¹ which represents the presence of substitutions on the benzene ring, indicating that the product thus obtained is a first maleimide resin of the present disclosure.

### PREPARATION EXAMPLE 2

98 g of maleic anhydride and a proper amount of toluene were loaded to a reaction tank and fully dissolved by stirring; then 338 g of 3,3′-dimethyl-4,4′-diamino-5,5′-di(tert-butyl) diphenylmethane was fully dissolved in N,N-dimethylformamide (DMF) solvent and loaded to the reaction tank from a constant pressure funnel within 0.5-1 hour; during the addition process, the temperature was kept at 95° C. and the reaction was stirred continuously. After stirring the reaction at 95° C. for another 0.5-1 hour, 10 mL of triethylamine, 200 mL of acetic anhydride and 0.5 g of sodium p-toluenesulfonate were added, followed by stirring the reaction at 95° C. for 3-4 hours and cooling the reaction to room temperature; the obtained solution was treated with iced water to precipitate the product, which was then recrystallized with ethyl acetate and dried to obtain a pale yellow solid Product A2.

### PREPARATION EXAMPLE 3

98 g of maleic anhydride and a proper amount of toluene were loaded to a reaction tank and fully dissolved by stirring; then 282 g of 3,3′-dimethyl-4,4′-diamino-5,5′-diisopropyl diphenyl ether was fully dissolved in N,N-dimethylformamide (DMF) solvent and loaded to the reaction tank from a constant pressure funnel within 0.5-1 hour; during the addition process, the temperature was kept at 95° C. and the reaction was stirred continuously. After stirring the reaction at 95° C. for another 0.5-1 hour, 10 mL of triethylamine, 200 mL of acetic anhydride and 0.5 g of sodium p-toluenesulfonate were added, followed by stirring the reaction at 95° C. for 3-4 hours and cooling the reaction to room temperature; the obtained solution was treated with iced water to precipitate the product, which was then recrystallized with ethyl acetate and dried to obtain a pale yellow solid Product A3.

For the property tests of Examples E1 to E11 and Comparative Examples C1 to C11 listed in Tables 2, 4, and 5, samples (specimens) were prepared as described below and tested under specified conditions as follows.

1. Prepreg: Resin composition from each Example (Table 1) and each Comparative Example (Table 3) was separately well-mixed to form a varnish, which was then loaded to an impregnation tank; a fiberglass fabric (e.g., 2116 E-glass fiber fabric or 7628 E-glass fiber fabric, both available from Asahi) was impregnated into the impregnation tank to adhere the resin composition onto the fiberglass fabric, followed by heating and baking at 145° C. for about 4 minutes to obtain a prepreg.

2. Copper-clad laminate (5-ply, formed by lamination of five prepregs): Two 18 μm RTF copper foils (reverse treated copper foils) and five prepregs obtained from 2116 E-glass fiber fabrics impregnated with each Example or Comparative Example and having a resin content of about 55% were prepared and stacked in the order of one RTF copper foil, five prepregs and one RTF copper foil, followed by lamination under vacuum at 30 kgf/cm² pressure and 200° C. for 2 hours to form a copper-clad laminate. Insulation layers between the two copper foils were formed by laminating five sheets of prepreg, and the resin content of the insulation layers is about 55%.

3. Copper-free laminate (5-ply, formed by lamination of five prepregs): Each aforesaid copper-clad laminate was etched to remove the two copper foils to obtain a copper-free laminate (5-ply), which was formed by laminating five sheets of prepreg and had a resin content of about 55%.

4. Four-layered circuit board comprising ultra-thin copper foil: Four prepregs obtained from 7628 E-glass fiber fabrics impregnated with each Example or Comparative Example and having a resin content of about 42% were prepared and stacked, and both sides of the stack were respectively covered with a copper foil, followed by lamination under vacuum at high temperature (200° C.) and high pressure (30 kgf/cm²) for 2 hours to form a copper-clad laminate. Then the copper-clad laminate was subject to a brown oxidation process to obtain a brown oxide treated copper-clad laminate. Two prepregs, which were made using 2116 E-glass fiber fabrics impregnated with the resin composition of the same Example or the same Comparative Example and had a resin content of about 55%, were respectively covered on both sides of the brown oxide treated copper-clad laminate; next, a 3 μm ultra-thin copper foil (MTHD18-V2) was covered on the outer sides of the two prepregs, and then the ultra-thin copper foil (with the copper foil surface adhered to the prepreg and the carrier layer away from the prepreg), a prepreg, the brown oxide treated copper-clad laminate, a prepreg and the ultra-thin copper foil were superimposed in said order, followed by lamination for 2 hours in vacuum at 200° C. to obtain an ultra-thin copper-containing laminate. Carrier copper on the ultra-thin copper surface of the ultra-thin copper-containing laminate was peeled off, and electroplating of the whole plate was performed without cleaning, such that the copper layer has a thickness of 35 μm to form a four-layered circuit board comprising ultra-thin copper foil.

Each sample was analyzed as described below.

1. Varnish Solubility

At 5° C. to 35° C., the resin composition from each Example or each Comparative Example listed in Table 1 and Table 3 was used to prepare a varnish and well mixed and stirred for 1-3 hours, and the varnish solubility was observed. If the resin composition was fully dissolved, a designation of “OK” is given; if the resin composition was not fully dissolved, a designation of “NG” is given. The resin compositions from Comparative Examples C1, C6, C8 and C10 were not fully dissolved, so no laminate could be prepared therefrom or tested.

2. Varnish Shelf Life

A varnish was prepared from the resin composition of each Example and Comparative Example according to Table 1 and Table 3; the varnish was well mixed and stirred for 1-3 hours and then stood still at 5° C. to 35° C. and observed to measure the duration before precipitation, turbidity or layer separation appears. If precipitation, turbidity or layer separation is not observed after standing the varnish for more than 15 days, a designation of “>15” is recorded. If precipitation, turbidity or layer separation appears within 2 days, a designation of “<2” is recorded.

3. Nitrogen Oxide Emission Rate

During the process of heating and baking the prepreg, an on-line monitoring system (model No. CEMS-V100) for volatile organic compounds available from Skyray Instrument Co., Ltd. was used to monitor the nitrogen oxide emission rate of the waste gas.

4. Prepreg Appearance

A prepreg obtained from 2116 E-glass fiber fabric impregnated with each Example or Comparative Example was subject to visual inspection of the surface to determine the presence of non-uniform or non-smooth surface such as crystal grains or sagging; if no crystal grains or sagging was observed, a designation of “OK” is given.

5. Radial Flow Via Fill Factor

By reference to the process disclosed in Chinese Patent No. 105956215 B, which is incorporated herein by reference in its entirety, a prepreg (resin content of about 55%) obtained from 2116 E-glass fiber fabric impregnated with each Example or Comparative Example was subject to the measurement of radial flow via fill factor, which represents the resin filling capability of a prepreg and ranges from 0.00 to 1.00, wherein higher value indicates higher filling capability, and a difference in radial flow via fill factor of greater than or equal to 0.10 represents a significant difference.

6. Laminate Appearance

A copper-free laminate (5-ply, formed by lamination of five prepregs) was subject to visual inspection to determine whether branch-like patterns, non-uniform resin flow and dry board are present on its edges; absence of branch-like patterns, non-uniform resin flow and dry board on its edges is designated as “OK”, and presence of non-uniform or non-smooth surface on its edges such as branch-like patterns, non-uniform resin flow or dry board is designated as “NG”.

7. Copper Foil (18 μm) Peeling Strength (P/S)

The copper-clad laminate (obtained by laminating five prepregs) was cut into a rectangular sample with a width of 24 mm and a length of greater than 60 mm, which was etched to remove surface copper foil to leave a rectangular copper foil with a width of 3.18 mm and a length of greater than 60 mm to be tested by using a tensile strength tester by reference to IPC-TM-650 2.4.8 at room temperature (about 25° C.) to measure the force (lb/in) required to separate the copper foil from the insulation layer of the laminate.

8. Copper Foil (3 μm) Peeling Strength (P/S)

The four-layered circuit board comprising ultra-thin copper foil was cut into a rectangular sample with a width of 24 mm and a length of greater than 60 mm, which was etched to remove surface copper foil to leave a rectangular copper foil with a width of 3.18 mm and a length of greater than 60 mm to be tested by using a tensile strength tester by reference to IPC-TM-650 2.4.8 at room temperature (about 25° C.) to measure the force (lb/in) required to separate the copper foil from the insulation layer of the laminate.

9. Glass Transition Temperature (Tg)

The copper-free laminate (obtained by laminating five prepregs) specimen was subject to glass transition temperature measurement. A dynamic mechanical analyzer (DMA) was used by reference to IPC-TM-650 2.4.24.4 “Glass Transition and Modulus of Materials Used in High Density Interconnection (HDI) and Microvias-DMA Method” to measure the glass transition temperature (° C.) of each specimen. Temperature interval during the measurement was set at 35-350° C. with a temperature increase rate of 2° C./minute; higher glass transition temperature is more preferred.

TABLE 1
Resin compositions of Examples E1 to E11 (in part by weight)

| Composition | | E1 | E2 | E3 | E4 | E5 | E6 | E7 | E8 | E9 | E10 | E11 |
|---|---|---|---|---|---|---|---|---|---|---|---|---|
| first maleimide | A1 | 20 | 4 | 30 | 5 | 25 | 20 | 20 | | | 10 | 15 |
| resin | A2 | | | | | | | | 20 | | 5 | |
| | A3 | | | | | | | | | 20 | 5 | |
| second maleimide resin | BMI-70 | 20 | 36 | 10 | 5 | 35 | 20 | 20 | | | 5 | 25 |
| | BMI-5100 | | | | | | | | 20 | 20 | | |
| | BMI-1000 | | | | | | | | | | 2 | |
| | BMI-2300 | | | | | | | | | | 5 | |
| | BMI-4000 | | | | | | | | | | 6 | |
| | BMI-3000 | | | | | | | | | | 2 | |
| unsaturated | OPE-2st | 40 | 40 | 40 | 40 | 40 | 50 | 20 | 40 | 40 | 40 | 30 |
| bond-containing | 1200 | | | | | | | | | | | |
| polyphenylene | SA-9000 | | | | | | | | | | | 10 |
| oxide | | | | | | | | | | | | |
| polyolefin | Ricon 257 | 10 | 10 | 10 | 10 | 10 | 5 | 20 | 10 | 10 | 10 | 5 |
| | B-1000 | | | | | | | | | | | 5 |
| inorganic filler | SC-2500 | 100 | 100 | 100 | 100 | 100 | 100 | 100 | 100 | 100 | 100 | 120 |
| | SVJ | | | | | | | | | | | |
| curing | 25B | 0.5 | 0.5 | 0.5 | 0.5 | 0.5 | 0.5 | 0.5 | 0.5 | 0.5 | 0.5 | 0.5 |
| accelerator | | | | | | | | | | | | |
| solvent | MEK | 100 | 100 | 100 | 100 | 100 | 100 | 100 | 100 | 100 | 100 | 100 |
| | DMAC | | | | | | | | | | | |

TABLE 2
Test results of resin compositions of Examples E1 to E11

| Item | Unit | E1 | E2 | E3 | E4 | E5 | E6 | E7 | E8 | E9 | E10 | E11 |
|---|---|---|---|---|---|---|---|---|---|---|---|---|
| varnish | — | OK | OK | OK | OK | OK | OK | OK | OK | OK | OK | OK |
| solubility | | | | | | | | | | | | |
| varnish shelf | day | >15 | >15 | >15 | >15 | >15 | >15 | >15 | >15 | >15 | >15 | >15 |
| life | | | | | | | | | | | | |
| nitrogen | kg/h | 0 | 0 | 0 | 0 | 0 | 0 | 0 | 0 | 0 | 0 | 0 |
| oxide | | | | | | | | | | | | |
| emission rate | | | | | | | | | | | | |
| prepreg | — | OK | OK | OK | OK | OK | OK | OK | OK | OK | OK | OK |
| appearance | | | | | | | | | | | | |
| radial flow | — | 0.95 | 0.85 | 0.98 | 1.00 | 0.80 | 0.80 | 0.80 | 0.95 | 0.93 | 0.84 | 1.00 |
| via fill factor | | | | | | | | | | | | |
| laminate | — | OK | OK | OK | OK | OK | OK | OK | OK | OK | OK | OK |
| appearance | | | | | | | | | | | | |
| P/S | lb/in | 4.1 | 4.3 | 3.5 | 4.4 | 3.5 | 3.6 | 4.3 | 4.0 | 4.3 | 4.0 | 4.3 |
| (18 μm | | | | | | | | | | | | |
| copper foil) | | | | | | | | | | | | |
| P/S | lb/in | 4.2 | 4.3 | 3.6 | 4.5 | 3.5 | 3.6 | 4.2 | 4.2 | 4.2 | 4.1 | 4.4 |
| (3 μm copper | | | | | | | | | | | | |
| foil) | | | | | | | | | | | | |
| Tg (DMA) | ° C. | 265 | 269 | 257 | 251 | 271 | 262 | 271 | 262 | 264 | 259 | 270 |

TABLE 3
Resin compositions of Comparative Examples C1 to C11 (in part by weight)

| Composition | | C1 | C2 | C3 | C4 | C5 | C6 | C7 | C8 | C9 | C10 | C11 |
|---|---|---|---|---|---|---|---|---|---|---|---|---|
| first maleimide | A1 | 40 | 40 | | 2 | 32 | | | | | | |
| resin | A2 | | | | | | | | | | | |
| | A3 | | | | | | | | | | | |
| second | BMI-70 | | | 40 | 38 | 8 | 20 | 20 | | | 20 | 20 |
| maleimide resin | BMI-5100 | | | | | | | | | | | |
| | BMI-1000 | | | | | | | | 4 | 4 | | |
| | BMI-2300 | | | | | | 20 | 20 | | | | |
| | BMI-4000 | | | | | | | | | | 20 | 20 |
| | BMI-3000 | | | | | | | | 36 | 36 | | |
| unsaturated | OPE-2st | 40 | 40 | 40 | 40 | 40 | 40 | 40 | 40 | 40 | 40 | 40 |
| bond-containing | 1200 | | | | | | | | | | | |
| polyphenylene | SA-9000 | | | | | | | | | | | |
| oxide | | | | | | | | | | | | |
| polyolefin | Ricon 257 | 10 | 10 | 10 | 10 | 10 | 10 | 10 | 10 | 10 | 10 | 10 |
| | B-1000 | | | | | | | | | | | |
| inorganic filler | SC-2500 | 100 | 100 | 100 | 100 | 100 | 100 | 100 | 100 | 100 | 100 | 100 |
| | SVJ | | | | | | | | | | | |
| curing | 25B | 0.5 | 0.5 | 0.5 | 0.5 | 0.5 | 0.5 | 0.5 | 0.5 | 0.5 | 0.5 | 0.5 |
| accelerator | | | | | | | | | | | | |
| solvent | MEK | 100 | 140 | 100 | 100 | 100 | 100 | | 100 | | 100 | |
| | DMAC | | | | | | | 100 | | 250 | | 100 |

TABLE 4
Test results of resin compositions of Comparative Examples C1 to C5

| Item | Unit | C1 | C2 | C3 | C4 | C5 |
|---|---|---|---|---|---|---|
| varnish solubility | — | NG | OK | OK | OK | OK |
| varnish shelf life | day | / | >15 | <2 | <2 | <2 |
| nitrogen oxide | kg/h | 0 | 0 | 0 | 0 | 0 |
| emission rate | | | | | | |
| prepreg | — | / | sagging | crystal grain | crystal grain | crystal grain |
| appearance | | | | | | |
| radial flow | — | / | 0.75 | 0.65 | 0.68 | 0.75 |
| via fill factor | | | | | | |
| laminate appearance | — | / | NG | NG | NG | NG |
| P/S | lb/in | / | 3.3 | 3.6 | 3.7 | 3.4 |
| (18 μm copper foil) | | | | | | |
| P/S | lb/in | / | 3.1 | 3.2 | 3.8 | 3.3 |
| (3 μm copper foil) | | | | | | |
| Tg (DMA) | ° C. | / | 253 | 259 | 258 | 255 |

TABLE 5
Test results of resin compositions of Comparative Examples C6 to C11

| Item | Unit | C6 | C7 | C8 | C9 | C10 | C11 |
|---|---|---|---|---|---|---|---|
| varnish solubility | — | NG | OK | NG | OK | NG | OK |
| varnish shelf life | day | / | >15 | / | >15 | / | >15 |
| nitrogen oxide | kg/h | 0 | 2.9 | 0 | 7.5 | 0 | 2.9 |
| emission rate | | | | | | | |
| prepreg | — | / | OK | / | sagging | / | OK |
| appearance | | | | | | | |
| radial flow | — | / | 0.20 | / | 0.00 | / | 0.65 |
| via fill factor | | | | | | | |
| laminate appearance | — | / | NG | / | NG | / | OK |
| P/S | lb/in | / | 4.4 | / | 3.2 | / | 3.3 |
| (18 μm copper foil) | | | | | | | |
| P/S | lb/in | / | 4.5 | / | 3.0 | / | 3.1 |
| (3 μm copper foil) | | | | | | | |
| Tg (DMA) | ° C. | / | 265 | / | 267 | / | 235 |

The following observations can be made from Table 1 to Table 5.

Compared with Comparative Example C1 in which the resin composition solely uses a first maleimide resin, the resin composition of Example E1, which contains a first maleimide resin and a second maleimide resin according to the present disclosure, achieves an excellent varnish solubility; in contrast, the resin composition of Comparative Example C1 is not completely dissolved and therefore is unable to make laminates for testing. In addition, compared with Comparative Example C2 which increases the amount of solvent methyl ethyl ketone (MEK) relative to Comparative Example C1, Example E1 achieves better prepreg appearance, higher radial flow via fill factor, better laminate appearance and higher copper foil peeling strength (18 μm and 3 μm copper foils).

Compared with Comparative Example C3 in which the resin composition solely uses a second maleimide resin, the resin composition of Example E1, which contains a first maleimide resin and a second maleimide resin according to the present disclosure, achieves an excellent varnish shelf life, better prepreg appearance, higher radial flow via fill factor, better laminate appearance and higher copper foil peeling strength (3 μm copper foil).

Compared with Comparative Examples C6, C8 and C10 in which the resin compositions use multiple second maleimide resins, the resin composition of Example E1 or E2, which contains a first maleimide resin and a second maleimide resin according to the present disclosure, achieves an excellent varnish solubility; in contrast, the resin compositions of Comparative Examples C6, C8 and C10 are not completely dissolved and therefore are unable to make laminates for testing. Moreover, compared with Comparative Examples C7, C9 and C11 which change the solvent from methyl ethyl ketone to N,N-dimethylacetamide relative to Comparative Examples C6, C8 and C10, Examples E1 and E2 are free of nitrogen oxide emission and both achieve improvements in at least one, more or all of the properties including prepreg appearance, radial flow via fill factor, laminate appearance, glass transition temperature, and copper foil peeling strength.

Compared with Comparative Example C4 or C5 in which the weight ratio of the first maleimide resin and the second maleimide resin is 0.5:9.5 or 8:2, Examples E1 to E11 individually use a resin composition in which the weight ratio of the first maleimide resin and the second maleimide resin ranges from 1.0:9.0 to 7.5:2.5 and therefore achieve an excellent varnish shelf life and achieve improvements in at least one, more or all of the properties including prepreg appearance, radial flow via fill factor, laminate appearance, and copper foil peeling strength.

Overall, it can be observed that by using a resin composition according to the present disclosure which comprises a first maleimide resin and a second maleimide resin at a weight ratio of from 1.0:9.0 to 7.5:2.5, improvements can be achieved in at least one or more properties including varnish solubility, varnish shelf life, prepreg appearance, radial flow via fill factor, laminate appearance, glass transition temperature, copper foil peeling strength, and free of nitrogen oxide emission.

The above detailed description is merely illustrative in nature and is not intended to limit the embodiments of the subject matter or the application and uses of such embodiments. As used herein, the term “exemplary” or similar expression means “serving as an example, instance, or illustration.” Any implementation described herein as exemplary is not necessarily to be construed as preferred or advantageous over other implementations, unless otherwise specified.

Moreover, while at least one exemplary example or comparative example has been presented in the foregoing detailed description, it should be appreciated that a vast number of variations exist. It should also be appreciated that the exemplary one or more embodiments described herein are not intended to limit the scope, applicability, or configuration of the claimed subject matter in any way. Rather, the foregoing detailed description will provide those skilled in the art with a convenient guide for implementing the described one or more embodiments and equivalents thereof. Also, the scope defined by the claims includes known equivalents and foreseeable equivalents at the time of filing this patent application.

What is claimed is:

1. A resin composition, comprising:
a first maleimide resin comprising a monomer of Formula (1) and/or a polymer thereof: 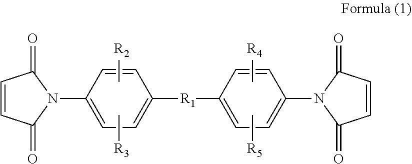
wherein R₁ is a covalent bond, —CH₂—, —CH(CH₃)—, —C(CH₃)₂—, —O—, —S—, —SO₂— or a carbonyl group; R₂, R₃, R₄ and R₅ each independently represent a hydrogen atom or an alkyl group, and at least one of R₂, R₃, R₄ and R₅ is an alkyl group having three or more carbon atoms; and
a second maleimide resin not comprising the monomer of Formula (1) and/or a polymer thereof;
wherein, in the resin composition, the first maleimide resin and the second maleimide resin have a weight ratio of 1.0:9.0 to 7.5:2.5.

2. The resin composition of claim 1, wherein the first maleimide resin comprises a structure of Formula (2) to Formula (4) or a combination thereof:

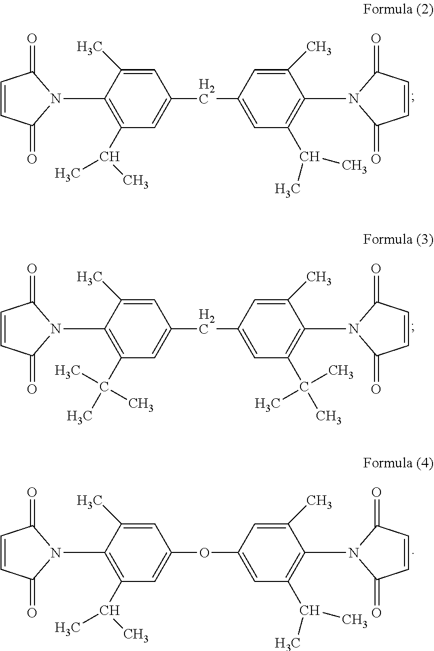 [SMILES: Cc1cc(Cc2cc(C)c(N3C(=O)C=CC3=O)c(C(C)C)c2)cc(C(C)C)c1N1C(=O)C=CC1=O ; Cc1cc(Cc2cc(C)c(N3C(=O)C=CC3=O)c(C(C)(C)C)c2)cc(C(C)(C)C)c1N1C(=O)C=CC1=O ; Cc1cc(Oc2cc(C)c(N3C(=O)C=CC3=O)c(C(C)C)c2)cc(C(C)C)c1N1C(=O)C=CC1=O]

3. The resin composition of claim 1, wherein the second maleimide resin comprises 4,4′-diphenylmethane bismaleimide, polyphenylmethane maleimide, bisphenol A diphenyl ether bismaleimide, 3,3′-dimethyl-5,5′-diethyl-4,4′-diphenylmethane bismaleimide, m-phenylene bismaleimide, 4-methyl-1,3-phenylene bismaleimide, 1,6-bismaleimide-(2,2,4-trimethyl)hexane, N-2,3-xylylmaleimide, N-2,6-xylylmaleimide, N-phenylmaleimide, vinyl benzyl maleimide, maleimide resin containing aliphatic long chain structure, prepolymer of diallyl compound and maleimide resin, prepolymer of diamine and maleimide resin, prepolymer of multi-functional amine and maleimide resin, prepolymer of acid phenol compound and maleimide resin, or a combination thereof.

4. The resin composition of claim 1, further comprising an unsaturated bond-containing resin.

5. The resin composition of claim 4, comprising 10 parts by weight to 60 parts by weight of a combination of the first maleimide resin and the second maleimide resin and 5 parts by weight to 70 parts by weight of the unsaturated bond-containing resin.

6. The resin composition of claim 4, wherein the unsaturated bond-containing resin comprises unsaturated bond-containing polyphenylene oxide and/or a modification thereof, polyolefin and/or a modification thereof, bis(vinylbenzyl) ether and/or a modification thereof, 1,2-bis(vinylphenyl) ethane and/or a modification thereof, divinylbenzene and/or a modification thereof, triallyl isocyanurate and/or a modification thereof, triallyl cyanurate and/or a modification thereof, 1,2,4-trivinyl cyclohexane and/or a modification thereof, diallyl bisphenol A and/or a modification thereof, styrene and/or a modification thereof, acrylate and/or a modification thereof, or a combination thereof.

7. The resin composition of claim 6, comprising 10 parts by weight to 60 parts by weight of a combination of the first maleimide resin and the second maleimide resin, 20 parts by weight to 50 parts by weight of the unsaturated bond-containing polyphenylene oxide and/or a modification thereof, and 5 parts by weight to 20 parts by weight of the polyolefin and/or a modification thereof.

8. The resin composition of claim 1, further comprising epoxy resin and/or a modification thereof, cyanate ester resin and/or a modification thereof, phenolic resin and/or a modification thereof, benzoxazine resin and/or a modification thereof, styrene maleic anhydride resin and/or a modification thereof, polyester and/or a modification thereof, amine curing agent and/or a modification thereof, polyamide and/or a modification thereof, polyimide and/or a modification thereof, or a combination thereof.

9. The resin composition of claim 1, further comprising flame retardant, inorganic filler, curing accelerator, solvent, silane coupling agent, surfactant, coloring agent, toughening agent or a combination thereof.

10. The resin composition of claim 9, wherein the solvent is absent of nitrogen in its molecular structure.

11. An article made from the resin composition of claim 1, comprising a prepreg, a resin film, a resin-coated copper, a laminate or a printed circuit board.

12. The article of claim 11, having a glass transition temperature as measured by using a dynamic mechanical analyzer by reference to IPC-TM-650 2.4.24.4 of greater than or equal to 250° C.

13. The article of claim 11, having a copper foil peeling strength as measured by using a tensile strength tester by reference to IPC-TM-650 2.4.8 of greater than or equal to 3.5 lb/in.

14. The article of claim 11, characterized by free of nitrogen oxide emission during its manufacturing process.
